(19) United States
(12) Patent Application Publication
(10) Pub. No.: US 2007/0121072 A1
(43) Pub. Date: May 31, 2007

(54) Liquid crystal lens, photographing apparatus and flash light emitting unit

(75) Inventors: Takeshi Misawa, Asaka-shi (JP); Hiroshi Endo, Asaka-shi (JP); Takashi Kato, Minami-Ashigara-shi (JP); Hitoshi Miyano, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/600,192

(22) Filed: Nov. 16, 2006

(30) Foreign Application Priority Data
Nov. 18, 2005 (JP) 2005-334189

(51) Int. Cl. G03B 21/32; G03B 19/18

(52) U.S. Cl. 352/38

(57) ABSTRACT

The liquid crystal lens of the invention has an optically transparent liquid crystal plate which includes a plurality of liquid crystal pixels divided two-dimensionally, and a liquid crystal drive section which selects only a part of the liquid crystal pixels simultaneously and controls voltage application to the selected liquid crystal pixels. The liquid crystal drive section performs voltage application control to the selected liquid crystal pixels so as to form, in the liquid crystal plate, a refractive index distribution of light which transmits the liquid crystal plate.

### BACKGROUND OF THE INVENTION

1. Field of the Invention

The present invention relates to a liquid crystal lens which uses a liquid crystal and in which a refractive index changes according to an applied voltage, and to an image taking apparatus which has an image taking optical system with a variable focal length, captures an object image which is incident through the image taking optical system, and generates image data, and to a flash light emitting unit.

2. Description of the Related Art

In a camera which is one of image taking apparatuses, flash light as image taking fill light is radiated toward an object from a light emitting unit in synch with a shutter operation when object brightness is insufficient in image taking. What is known as a light emitting unit is a light emitting unit including an arc tube which emits flash light, and a reflector which reflects the flash light emitted from the arc tube (reflective shade).

As such a light emitting unit, a technique which has means which makes a light irradiation direction variable, and which corrects displacement between a shooting lens optical axis and a light emitting unit optical axis by making the shooting lens optical axis and the light emitting unit optical axis always intersect at a position of an object is proposed (see Japanese Patent Laid-Open No. 57-122423).

In addition, a technique which makes an irradiation angle variable by changing a form of a reflector from an approximately elliptical to an approximately paraboloid form is proposed (see Japanese Patent Laid-Open No. H2-196228).

Furthermore, a technique which changes an irradiation direction of a light emitting section automatically by operating an irradiation direction deflection mechanism on the basis of object information from an image taking screen is proposed (see Japanese Patent Laid-Open No. H4-14029).

Moreover, a technique which makes a focal length of the liquid crystal micro lens, using a liquid crystal, variable by dividing an electrode into four parts and applying different voltages to respective four parts which are divided is proposed (see Japanese Patent Laid-Open No. H11-109304).

Further, in a diffraction type liquid crystal lens which fills liquid crystal elements between transparent substrates, a technique which has a light distribution film which has two or more concentric regions in which orientation processing is given so that orientation directions of the liquid crystal elements may be different, and makes a focal length variable in an optical axis direction is proposed (see Japanese Patent Laid-Open No. 2002-357804).

In addition, in a liquid crystal lens which is provided in an optical pick-up apparatus, a technique which makes a focal length of a light beam variable in an optical axis direction according to a drive signal supplied is proposed (see Japanese Patent Laid-Open No. 2005-18840).

Furthermore, as a light emitting unit which emits light, an AF fill light emitting apparatus which assists an auto-focusing (AF) function by emitting distance measurement fill light from a light source (LED) at the time of image taking under low illuminance is also known. The distance measurement fill light which is emitted from the AF fill light emitting apparatus is radiated to an object, and a focusing operation is performed on the basis of the distance measurement fill light which is reflected by the object. In this focusing operation, for example, so-called “hill-climbing type” continuous AF processing is performed. Thus, a focused position is decided by gradually moving a focus lens till a maximal point of an evaluation value while checking directions of increase and decrease of a focal evaluation value with performing minute movement of a focus lens along an optical axis back and forth.

Since all the techniques which are proposed in Japanese Patent Laid-Open Nos. 57-122423, H2-196228, and H4-14029 require a mechanism of changing mechanical structure at the time of changing an irradiation direction and an irradiation angle of light variable, there arises a problem of interfering with miniaturization and weight saving of a light emitting unit.

In addition, the technique proposed in Japanese Patent Laid-Open No. H11-109304 requires four power sources for applying different voltages to respective four parts of the electrode when making a focal length of the liquid crystal micro lens variable. Hence, there also arise a problem of interfering miniaturization and weight saving of a light emitting unit.

Furthermore, since the technique proposed in Japanese Patent Laid-Open Nos. 2002-357804 and 2005-18840 is a technique which makes a focal length variable in an optical axis direction, there is a problem that it is difficult to make a focal length variable except an optical axis direction.

Moreover, since an AF fill light emitting apparatus which is a light emitting unit which emits light is arranged generally in a position off an optical axis in terms of layout, a direction of the distance measurement fill light which is emitted from the AF fill light emitting apparatus falls in a direction of intersecting with the optical axis. Hence, it has a defect that a focal length of the lens in which the distance measurement fill light can cover is within a certain limited range, and it does not reach a distant position. Here, although it is conceivable to enlarge a light source which emits distance measurement fill light, there arises a problem of interfering with miniaturization of an AF fill light emitting apparatus.

In consideration of the situation mentioned above, the present invention aims at providing a liquid crystal lens which can achieve miniaturization and weight saving of an apparatus, and can transmit light, which is incident, in an optical axis direction and also a direction other than the optical axis direction, and an image taking apparatus which is miniaturized and weight-saved, and can make an irradiation position or an irradiation angle of fill light variable, and a flash light emitting unit incorporating the liquid crystal lens.

### SUMMARY OF THE INVENTION

A liquid crystal lens of the present invention has an optically transparent liquid crystal plate which is composed of two or more liquid crystal pixels divided two-dimensionally, and a liquid crystal drive section which selects only a part of the two or more liquid crystal pixels at the same time and controls voltage application to the liquid crystal pixels which are selected, so as to form, in the liquid crystal plate, a refractive index distribution of light transmitted through the liquid crystal plate, by voltage application control to the liquid crystal pixels which are selected.

The liquid crystal lens of the present invention is made with paying attention to that a response speed of a liquid crystal used for the liquid crystal lens is comparatively slow, and hence, it is also possible to keep the refractive index distribution since a state of the liquid crystal is kept even if voltages are applied to only a part at the same time.

In addition, it is possible to make also a center and a distribution itself of a refractive index distribution variable by using two or more liquid crystal pixels divided two-dimensionally. For example, it is possible to form in the liquid crystal plate a first refractive index distribution that light is transmitted from a center section of the liquid crystal plate, by selecting only a first part of two or more liquid crystal pixels at the same time to apply a predetermined voltage, or form in the liquid crystal plate a second refractive index distribution that light is transmitted from a left section of the liquid crystal plate by selecting only a second part of the two or more liquid crystal pixels at the same time to apply a predetermined voltage. Hence, it is possible to emit light in an optical axis direction or a direction other than the optical axis direction with a single power source.

Here, it is preferable that the voltage application control to the selected liquid crystal pixels in the liquid crystal lens of the present invention is performed to liquid crystal pixels outside an approximate distribution range of the refractive index distribution.

Hereby, when the liquid crystal lens of the present invention is used for a flash light emitting unit, or an AF light emitting unit, it is possible to radiate light, which is radiated from one of those light emitting units, toward the front, left side, lower left side, or the like of an object, and hence, it is possible to raise condensing efficiency in the front, left side, lower left side, or the like.

In addition, it is a preferable that the voltage application control to the selected liquid crystal pixels in the liquid crystal lens of the present invention is performed to liquid crystal pixels inside an approximate distribution range of the refractive index distribution.

Hereby, when the liquid crystal lens of the present invention is used for a flash light emitting unit, or an AF light emitting unit, it is possible to form a refractive index distribution according to a focal length of an image taking optical system. Hence, it is possible to radiate flash light or distance measurement fill light on an object located in a long distance by forming the refractive index distribution so that a refractive index may be little changed, and by making the flash light and the distance measurement fill light from the liquid crystal lens reach up to a long distance. Alternatively it is possible to radiate flash light or distance measurement fill light on an object located in a short distance by forming a refractive index distribution so that a refractive index of a liquid crystal lens may be significantly changed and by making the flash light and the distance measurement fill light from the liquid crystal lens reach in a short distance.

Furthermore, it is also preferable that voltage application control to the selected liquid crystal pixels in the liquid crystal lens of the present invention is performed in sequential selection.

Hereby, it is possible to simplify configuration of a circuit which performs voltage application control to the selected liquid crystal pixels.

In addition, in an image taking apparatus which has an image taking optical system with a variable focal length, captures an object image which is incident through the image taking optical system, and generates image data, the image taking apparatus of the present invention includes:

a light source which radiates fill light toward an object in image taking;

an optically transparent liquid crystal plate which is arranged in front of the light source, and is composed of two or more liquid crystal pixels divided two-dimensionally; and

a liquid crystal drive section which selects only a part of the liquid crystal pixels simultaneously and controls voltage application to the selected liquid crystal pixels, so as to form in the liquid crystal plate a refractive index distribution, according to a focal length of the image taking optical system, of the fill light emitted from the light source.

The image taking apparatus of the present invention is made with paying attention to that a response speed of a liquid crystal used for the liquid crystal lens is comparatively slow, and hence, it is also possible to keep a refractive index distribution since a state of the liquid crystal is kept even if a voltage is applied to only a part at the same time. In addition, it is possible to make also a center and a distribution itself of a refractive index distribution variable by using two or more liquid crystal pixels divided two-dimensionally. For example, it is possible to form in the liquid crystal plate a first refractive index distribution according to a first focus length by selecting only a first part of two or more liquid crystal pixels at the same time to apply a predetermined voltage, and to emit fill light from a center section of the liquid crystal plate, or to form in the liquid crystal plate a second refractive index distribution according to a second focus length by selecting only a second part of the two or more liquid crystal pixels at the same time to apply a predetermined voltage, and to emit fill light from a left section of the liquid crystal plate. Hence, it is possible to provide the image taking apparatus which is given miniaturization and weight saving, and can make an irradiation position or an irradiation angle of fill light variable.

Here, it is preferable that the voltage application control to the selected liquid crystal pixels in the image taking apparatus of the present invention is performed to liquid crystal pixels outside an approximate distribution range of the refractive index distribution.

Hereby, it is possible to radiate light, which is radiated from a flash light emitting unit or an AF light emitting unit, which constructs the image taking apparatus of the present invention, toward the front, left side, lower left side, or the like of an object, and hence, it is possible to raise condensing efficiency in the front, left side, lower left side, or the like.

In addition, it is a preferable that the voltage application control to the selected liquid crystal pixels in the image taking apparatus of the present invention is performed to liquid crystal pixels inside an approximate distribution range of the refractive index distribution.

Hereby, in a flash light emitting unit, or an AF light emitting unit which construct the image taking apparatus of the present invention, it is possible to form a refractive index distribution according to a focal length of an image taking optical system. Hence, it is possible to radiate flash light or distance measurement fill light on an object located in a long distance by making the flash light and the distance measurement fill light reach up to a long distance, or to radiate the flash light or distance measurement fill light on an object located in a short distance by making the flash light and the distance measurement fill light reach in a short distance.

Furthermore, it is also preferable that voltage application control to the selected liquid crystal pixels in the image taking apparatus of the present invention is performed in sequential selection.

Hereby, it is possible to simplify configuration of a circuit which performs voltage application control to the selected liquid crystal pixels.

Additionally, a flash light emitting unit of the present invention has:

a light source;

an optically transparent liquid crystal plate which is arranged in front of the light source, and includes a plurality of liquid crystal pixels divided two-dimensionally; and

a liquid crystal drive section which selects only a part of the liquid crystal pixels simultaneously and controls voltage application to the selected liquid crystal pixels, so as to form in the liquid crystal plate a refractive index distribution of the fill light emitted from the light source.

The flash light emitting unit of the present invention is made with paying attention to that a response speed of a liquid crystal used for the liquid crystal lens is comparatively slow, and hence, it is also possible to keep a refractive index distribution since a state of the liquid crystal is kept even if a voltage is applied to only a part at the same time. In addition, it is possible to make also a center and a distribution itself of a refractive index distribution variable by using two or more liquid crystal pixels divided two-dimensionally. For example, it is possible to form in the liquid crystal plate a first refractive index distribution according to a first focus length by selecting only a first part of two or more liquid crystal pixels at the same time to apply a predetermined voltage, and to emit fill light from a center section of the liquid crystal plate, or to form in the liquid crystal plate a second refractive index distribution according to a second focus length by selecting only a second part of the two or more liquid crystal pixels at the same time to apply a predetermined voltage, and to emit fill light from a left section of the liquid crystal plate. Hence, it is possible to provide the flash light emitting unit which is given miniaturization and weight saving, and can make an irradiation position or an irradiation angle of fill light variable.

Here, it is preferable that the voltage application control to the selected liquid crystal pixels in the flash light emitting unit of the present invention is performed to liquid crystal pixels outside an approximate distribution range of the refractive index distribution.

Hereby, it is possible to radiate light, which is radiated from a flash light emitting unit or an AF light emitting unit, which constructs the image taking apparatus of the present invention, toward the front, left side, lower left side, or the like of an object, and hence, it is possible to raise condensing efficiency in the front, left side, lower left side, or the like.

In addition, it is a preferable that the voltage application control to the selected liquid crystal pixels in the flash light emitting unit of the present invention is performed to liquid crystal pixels inside an approximate distribution range of the refractive index distribution.

Hereby, in the flash light emitting unit, or the AF light emitting unit, it is possible to form a refractive index distribution of the light emitted from the light source. Hence, it is possible to radiate flash light or distance measurement fill light on an object located in a long distance by making the flash light and the distance measurement fill light reach up to a long distance, or to radiate the flash light or distance measurement fill light on an object located in a short distance by making the flash light and the distance measurement fill light reach in a short distance.

Furthermore, it is also preferable that voltage application control to the selected liquid crystal pixels in the flash light emitting unit of the present invention is performed in sequential selection.

Hereby, it is possible to simplify configuration of the circuit which performs voltage application control to the selected liquid crystal pixels.

As described above, the present invention can provide the liquid crystal lens which can achieve miniaturization and weight saving of an apparatus, and can transmit light, which is incident, in an optical axis direction and also a direction other than the optical axis direction, and the image taking apparatus and the flash light emitting unit which are given miniaturization and weight saving, and can make an irradiation position and an irradiation angle of fill light variable.

### BRIEF DESCRIPTION OF THE DRAWINGS

FIG. 1 is a sectional view of a first embodiment of a liquid crystal lens of the present invention;

FIG. 2 is a diagram schematically showing transparent electrodes and transparent XY address selection sections which construct the liquid crystal lens shown in FIG. 1;

FIGS. 3A through 3C are drawings showing examples that the transparent XY address selection sections shown in FIG. 2 select a part of the two or more liquid crystal pixels of the transparent electrodes;

FIGS. 4A through 4C are drawings showing other examples that the transparent XY address selection sections shown in FIG. 2 select a part of the two or more liquid crystal pixels of the transparent electrodes;

FIGS. 5A and 5B are external perspective views of a digital camera which is a first embodiment of an image taking apparatus of the present invention;

FIG. 6 is a block diagram showing circuit configuration of the digital camera shown in FIGS. 5A and 5B;

FIG. 7 is a diagram showing positional relation among a light source, a reflector, and a liquid crystal lens which construct the flash light emitting unit shown in FIG. 6;

FIG. 8 is a diagram showing a state that an irradiation position and irradiation angle of flash light which is emitted from the light source shown in FIG. 7 are made variable with the liquid crystal lens;

FIGS. 9A and 9B are external perspective views of a digital camera which is a second embodiment of the image taking apparatus of the present invention;

FIG. 10 is a block diagram showing circuit configuration of the digital camera shown in FIGS. 9A and 9B;

FIG. 11 is a diagram showing configuration of the light source shown in FIG. 10;

FIG. 12 is a diagram showing positional relation between the light source and the liquid crystal lens which are shown in FIG. 11; and

FIG. 13 is a drawing showing a state that an irradiation position and an irradiation angle of distance measurement fill light which is emitted from the light source shown in FIG. 12 are made variable with the liquid crystal lens.

### DETAILED DESCRIPTION OF THE PREFERRED INVENTION

Hereafter, embodiments of the present invention will be explained with reference to the attached drawings.

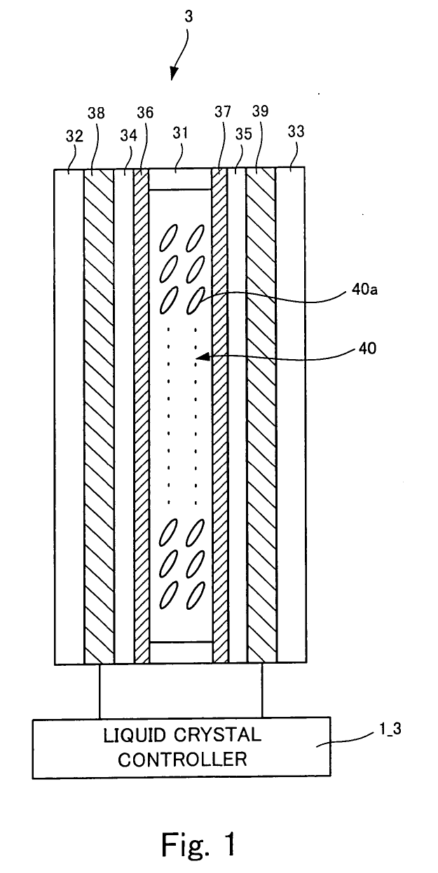

FIG. 1 is a sectional view of a first embodiment of a liquid crystal lens of the present invention.

A liquid crystal lens 3 shown in FIG. 1 has a spacer 31, tabular transparent substrates 32 and 33 arranged oppositely through the spacer 31, transparent XY address selection sections 38 and 39 arranged inside the transparent substrates 32 and 33, transparent electrodes 34 and 35 arranged inside the transparent XY address selection sections 38 and 39, light distribution films 36 and 37 arranged inside the transparent electrodes 34 and 35, and liquid crystal 40 filled in a space defined by the spacer 31 and light distribution films 36 and 37. The liquid crystal 40 has liquid crystal molecules 40a.

The transparent substrates 32 and 33 are formed of a material which has a high transmission factor in a wavelength band of incident light, and glass, a high polymer film, or the like can be used for them.

The transparent electrodes 34 and 35 are equivalent to the examples of the optically transparent liquid crystal plates called in the present invention, and, although their details will be mentioned later, they are optically transparent liquid crystal plates which are composed of two or more liquid crystal pixels divided two-dimensionally.

The transparent XY address selection sections 38 and 39 are equivalent to examples of the liquid crystal drive sections called in the present invention, and, although details will be described later, they select only a part of the two or more liquid crystal pixels at the same time, and control voltage application to the selected liquid crystal pixels with a control signal from an Liquid crystal controller 1_3.

The light distribution films 36 and 37 are for orienting the liquid crystal molecules 40a in a predetermined array direction, when a voltage is not applied to the transparent electrodes 34 and 35.

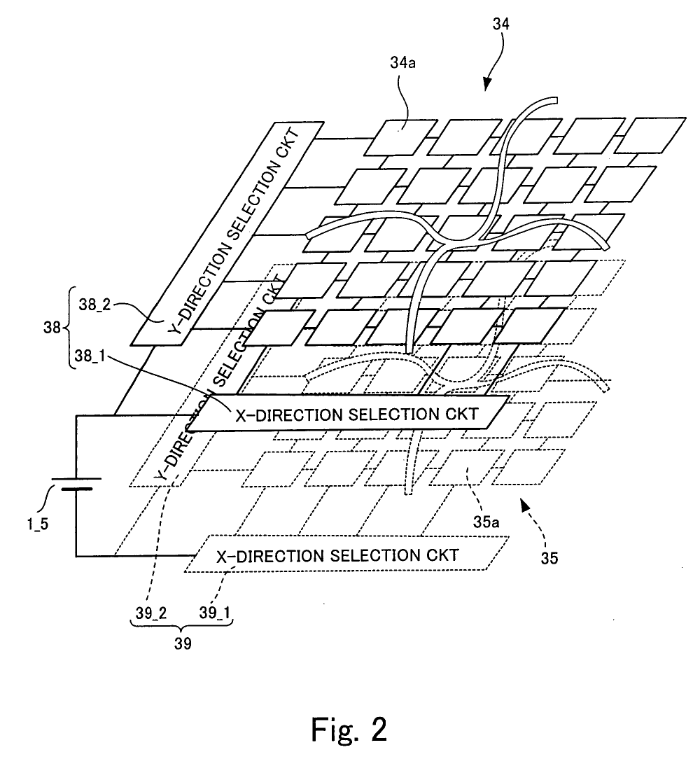

FIG. 2 is a diagram schematically showing transparent electrodes and transparent XY address selection sections which construct the liquid crystal lens shown in FIG. 1.

FIG. 2 shows the transparent electrodes 34 and 35 which construct the liquid crystal lens 3, the transparent XY address selection section 38 which is composed of an X-direction selection circuit 38_1 and a Y-direction selection circuit 38_2, and the transparent XY address selection section 39 which is composed of an X-direction selection circuit 39_1 and a Y-direction selection circuit 39-2.

The transparent electrode 34 is the electrode which is composed of two or more liquid crystal pixels 34a divided two-dimensionally. In addition, the transparent electrode 35 is an electrode which is composed of two or more liquid crystal pixels 35a divided two-dimensionally.

While voltages are supplied from a power source 1_5 into the X-direction selection circuit 38_1 and the Y-direction selection circuit 38_2, control signals from the liquid crystal controller 1_3 shown in FIG. 1 are inputted into them. In addition, while voltages are supplied from the power source 1_5, control signals from the liquid crystal controller 1_3 shown in FIG. 1 are inputted into the X-direction selection circuit 39_1 and the Y-direction selection circuit 39_2.

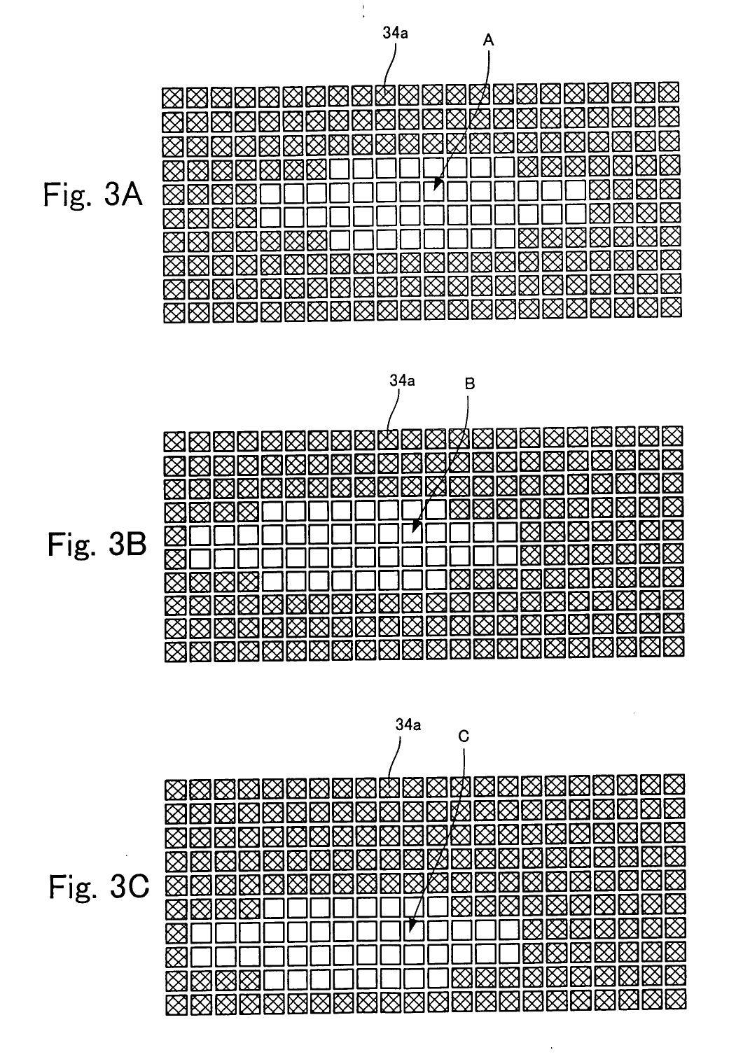

FIGS. 3A through 3C are drawings showing examples that the transparent XY address selection sections shown in FIG. 2 select a part of the two or more liquid crystal pixels of the transparent electrodes.

In addition, here, although an example of selecting a part of two or more liquid crystal pixels 34a of the transparent electrode 34 by the transparent XY address selection section 38 is explained, the transparent XY address selection section 39 selects also a part of the two or more liquid crystal pixels 35a of the transparent electrode 35 together which are equivalent to the part of the two or more liquid crystal pixels 34a of the transparent electrode 34.

FIG. 3A shows a state that the transparent XY address selection section 38 selects the liquid crystal pixels 34a in a peripheral section shown by hatching except a center section A in the two or more liquid crystal pixels 34a of the transparent electrode 34. Specifically, addresses corresponding to the peripheral section except the center section A are specified (turned on) one by one by the transparent XY address selection section 38, the liquid crystal pixels 34a in the peripheral section are selected one by one, and a voltage with a predetermined value is applied to those liquid crystal pixels 34a one by one. Here, since a reaction rate of the liquid crystal 40 is comparatively slow, the liquid crystal pixels 34a in the peripheral section, as shown in FIG. 3A, are to be selected almost simultaneously. In such a state, the array direction of the liquid crystal molecules 38a in the peripheral section is in a state perpendicular to an optical axis. On the other hand, the array direction of the liquid crystal molecules 38a in the center section A is in a state horizontal to the optical axis. Hence, light which is incident into this liquid crystal lens 3 is to be transmitted from the center section A. Therefore, although details will be described later, when this liquid crystal lens 3 is used for a flash light emitting unit, or an AF light emitting unit, light which is radiated from one of those light emitting units is radiated toward the front of an object in the state shown in FIG. 3A. In addition, a depth of focus is controllable with ON/OFF time of addresses, and also is controllable with a voltage when an applied voltage is controllable.

Here, when it is desired to radiate light, which is radiated from the light emitting unit, toward the left side of an object, as shown in FIG. 3B, addresses corresponding to the peripheral section except the left center section B are sequentially designated (turned on). Hereby, a voltage with a predetermined value is applied to the liquid crystal pixels 34a, which are arranged with corresponding to those addresses, one by one. Hence, light which is incident into this liquid crystal lens 3 is to be transmitted from the left center section B. In this manner, it is possible to radiate light, which is radiated from the light emitting unit, toward the left side of the object.

In addition, when it is desired to radiate light, which is radiated from the light emitting unit, toward the lower left side of an object, as shown in FIG. 3C, addresses corresponding to the peripheral section except the lower left section C are sequentially designated (turned on). Hereby, a predetermined voltage is applied to the liquid crystal pixels 34a, which are arranged with corresponding to those addresses, one by one. Hence, light which is incident into this liquid crystal lens 3 is to be transmitted from the lower left section C. In this manner, it is possible to radiate light, which is radiated from this light emitting unit, toward the lower left side of the object.

Furthermore, here, the example of applying a voltage with such a value that an array direction of the liquid crystal pixels 34a in the peripheral section is in a state perpendicular to the optical axis to those liquid crystals pixels 34a is explained. But, it is possible to achieve a concave (or convex) lens function by applying a voltage with magnitude, in which array directions of the liquid crystal pixels 34a in the peripheral section have a predetermined angle to the optical axis, to these liquid crystals pixels 34a.

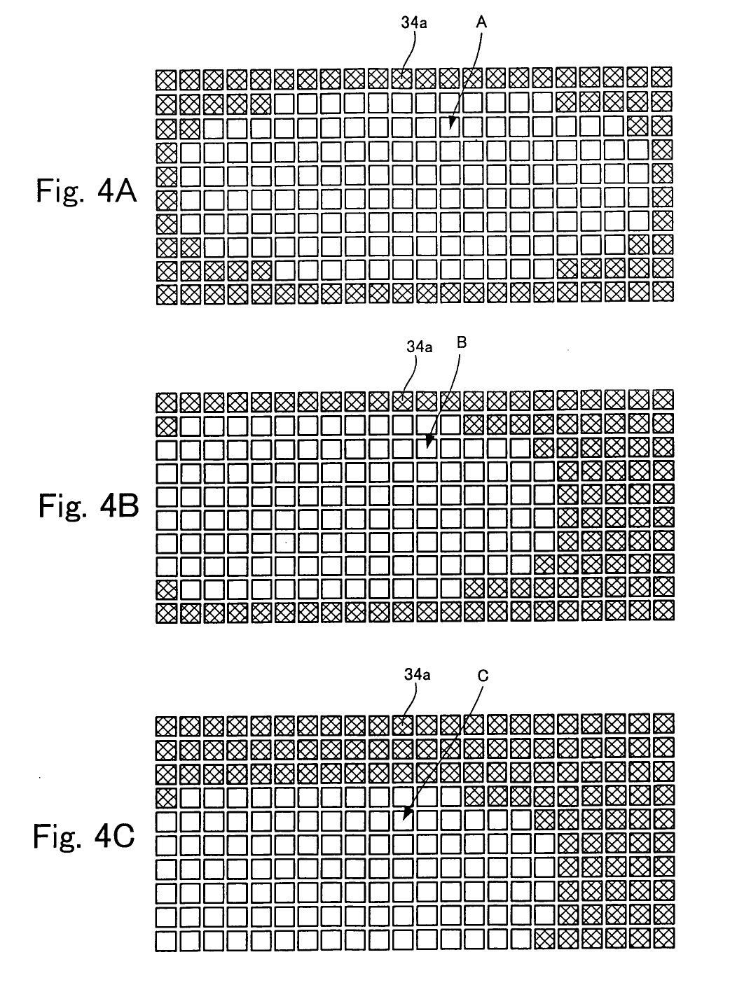

FIGS. 4A through 4C are drawings showing other examples that the transparent XY address selection sections shown in FIG. 2 select a part of the two or more liquid crystal pixels of the transparent electrodes.

FIG. 4A shows a state that the transparent XY address selection section 38 sequentially selects the liquid crystal pixels 34a in the peripheral section shown by hatching except the center section A in the two or more liquid crystal pixels 34a of the transparent electrode 34. Here, since an area of the center section A is larger than an area of the peripheral section, most of the light which is incident into the liquid crystal lens 3 is to be transmitted from the center section A.

In addition, although it does not limit to explanation of this figure, the part to be selected may become reverse (exclusive) depending on a liquid crystal and initial orientation.

Moreover, when it is desired to radiate a large part of light, which is radiated from the light emitting unit, toward the left side of an object, as shown in FIG. 4B, the liquid crystal pixels 34a in the peripheral section except the left section B are sequentially selected. Hereby, the large part of light which is incident into this liquid crystal lens 3 is to be transmitted from the left section B.

Further, when it is desired to radiate a large part of light, which is radiated from the light emitting units, toward the lower left side of an object, as shown in FIG. 4C, the liquid crystal pixels 34a in the peripheral section except the lower left section C are sequentially selected. Hereby, the large part of light which is incident into this liquid crystal lens 3 is to be transmitted from the lower left section C. Hereby, it is possible to raise condensing efficiency.

The liquid crystal lens 3 of this embodiment can form in the transparent electrodes 34 and 35 a first refractive index distribution that light is emitted from center sections of the transparent electrodes 34 and 35 by sequentially selecting only the peripheral section, which is shown in FIG. 3A, of the two or more liquid crystal pixels 34a and 35a, which are divided two-dimensionally, at the same time to apply a predetermined voltage, or can form in the transparent electrodes 34 and 35 a second refractive index distribution that light is emitted from left sections of the transparent electrodes 34 and 35 by sequentially selecting only the peripheral section, which is shown in FIG. 3B, of the two or more liquid crystal pixels 34a and 35a, which are divided two-dimensionally, at the same time to apply a predetermined voltage. Hence, it is possible to achieve miniaturization and weight saving of an apparatus, and to transmit light, which is incident, in an optical axis direction and also a direction other than the optical axis direction.

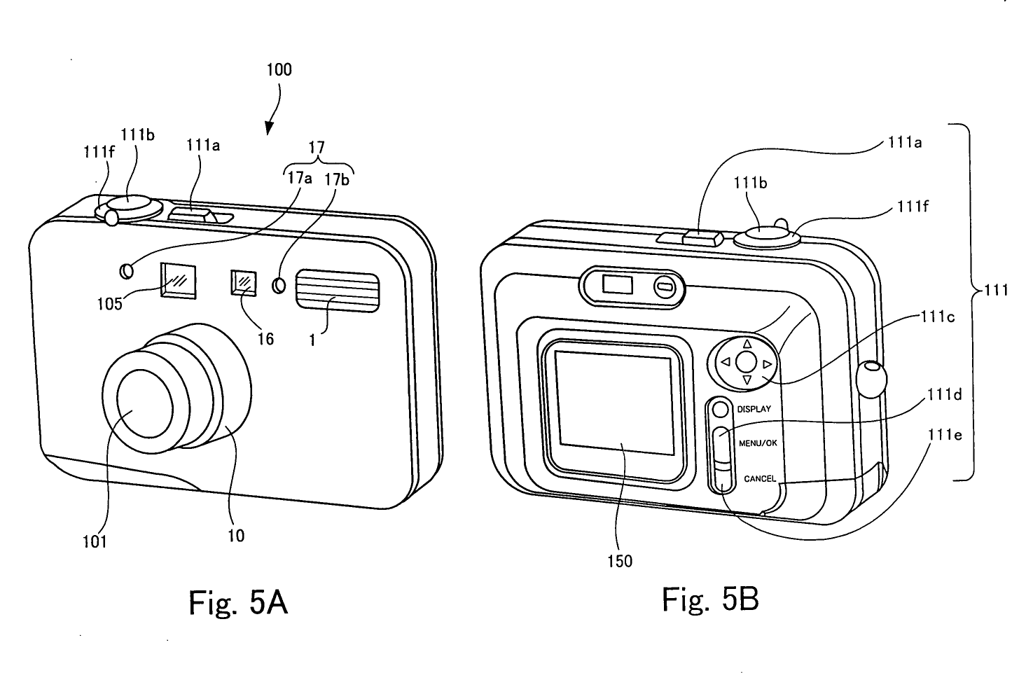

FIGS. 5A and 5B are external perspective views of a digital camera which is a first embodiment of the image taking apparatus of the present invention.

FIG. 5A shows a drawing in view of the upper front part of the digital camera which is the first embodiment of the image taking apparatus of the present invention. In addition, FIG. 5B shows a drawing in view of the upper back part of the digital camera which is the first embodiment of the image taking apparatus of the present invention.

The digital camera 100 shown in FIGS. 5A and 5B is a digital camera which has an image taking optical system with a variable focal length, and captures an object image, which is incident through the image taking optical system, to generate image data.

As shown in FIG. 5A, a lens barrel 10 is arranged in the center of a camera body of the digital camera 100 of this embodiment. In the lens barrel 10, the image taking optical system including a shooting lens 101 in which a zoom lens is embedded, and an image of an object is guided through the image taking optical system up to a CCD solid state image pickup device (hereafter, this is called a CCD) which is an image pickup device arranged inside the digital camera 100.

In addition, a finder 105, a metering section 16, a distance measurement section 17, and a flash light emitting unit 1 are arranged in the upper part of the lens barrel 10 of the digital camera 100 shown in FIG. 5A. In order to obtain a suitable exposure value in image taking, the metering section 16 measures a metering range with a metering sensor, and obtains a metering value. The distance measurement section 17 has AF receiving windows 17a and 17b arranged in the positions mutually separated by a predetermined distance, and receives reflected light which is the spontaneously scattered light (the flash light emitting unit 1, sunlight, or the like) from an object with a light-receiving device through these AF receiving windows 17a and 17b to measure an object distance by using a so-called principle of triangular distance measuring. The flash light emitting unit 1 has the liquid crystal lens 3 mentioned above.

In addition, as shown in FIG. 5B, an operating switch group 111 for performing various operations when a user uses this digital camera 100 is provided in the backface and the upper face of the digital camera 100 of this embodiment.

This operating switch group 111 includes a shutter button 111b, a cross key 111c, a menu/OK key 111d, a cancel key 111e, a mode lever 111f, and the like as well as a power switch 111a for operating the digital camera 100. The mode lever 111f in this operating switch group 111 switches a playback mode and a shooting mode, and further switches a moving image mode and a still image mode in the shooting mode. When this mode lever 111f is switched to the shooting mode, a through image is displayed. When the shutter button 111b is pressed with looking at the through image, image taking of an object is performed. On the other hand, when being switched to the playback mode, a playback display of a shot image is performed on a LCD panel 150.

In addition, a focal length is changed by the shooting lens 101, provided in the lens barrel 10, being moved along the optical axis between a wide (wide angle) end and a tele (telescopic) end by the operation of the cross key 111c.

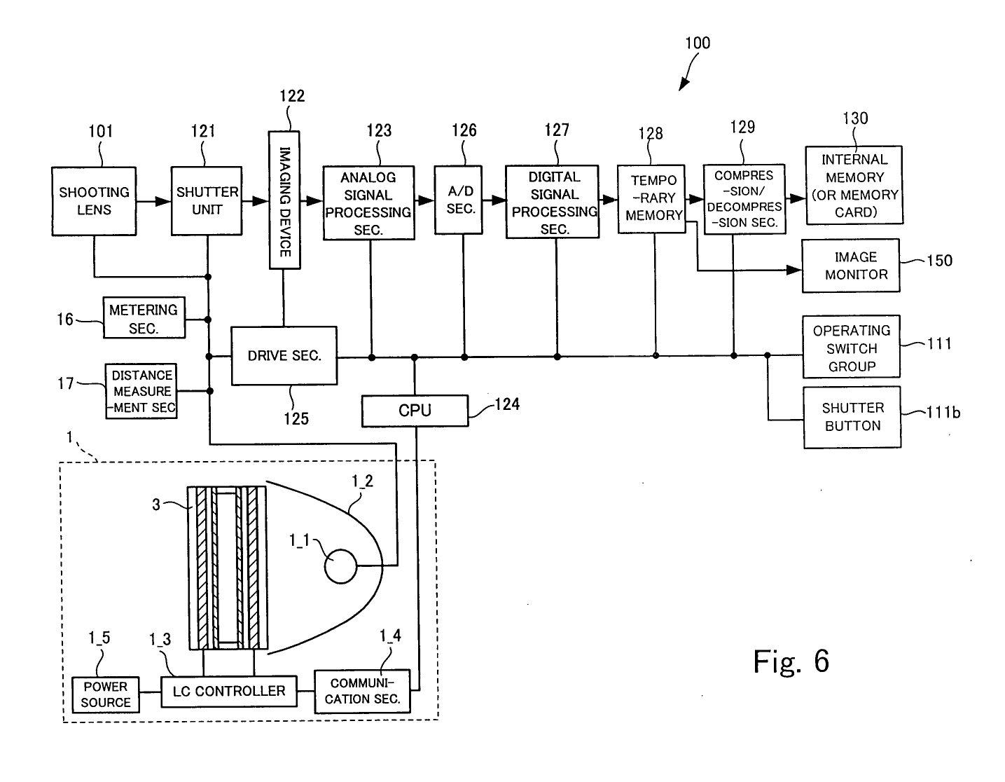

FIG. 6 is a block diagram showing circuit configuration of the digital camera shown in FIGS. 5A and 5B.

This digital camera 100 has the shooting lens 101, metering section 16, distance measurement section 17, and flash light emitting unit 1. In addition, the configuration of the flash light emitting section 1 will be mentioned later.

Furthermore, this digital camera 100 has a shutter unit 121, an imaging device (CCD) 122, an analog signal processing section 123, a CPU 124 which controls operations of this digital camera 100 as a whole, a drive circuit 125, and an A/D (analog to digital) section 126. The drive circuit 125 drives the shooting lens 101, shutter unit 121, imaging device 122, metering section 16, distance measurement section 17, and flash light emitting section 1 according to the image taking conditions.

Object light passing through the shooting lens 101 and shutter unit 121 is incident into the imaging device 122. The imaging device 122 converts the incident object light into an analog image signal which is an electric signal, and outputs it to an analog signal processing section 123.

The analog signal processing section 123 gives noise reduction processing and the like to the analog image signal outputted from the imaging device 122, and outputs the analog image signal, which is given the processing and the like, to the A/D section 126. The A/D section 126 gives A/D (analog to digital) conversion processing to the analog image signal and outputs a digital image signal.

In addition, the digital camera 100 has a digital signal processing section 127, temporary memory 128, a compression/decompression section 129, internal memory (or a memory card) 130, and an image monitor 150. A digital image signal which is converted into digital by being given A/D conversion processing by the A/D section 126 is inputted into the digital signal processing section 127. The digital signal processing section 127 gives predetermined digital signal processing to the inputted digital image signal to complete image data which represents the object image taken by the shooting operation, and stores it temporarily in the temporary memory 128. The data stored in the temporary memory 128 is compressed by the compression/decompression section 129, and is recorded in the internal memory (or memory card) 130. In addition, a compression process may be skipped depending on a shooting mode, and may be directly recorded in the internal memory 130. The data stored in the temporary memory 128 is read by the image monitor 150, and, hereby, the image of the object is displayed on the image monitor 150.

Furthermore, the digital camera 100 has the operating switch group 111 mentioned above. In image taking, the operating switch group 111 is operated for a desired image taking state to be set, and the shutter button 111b is depressed. Here, when object brightness is insufficient, flash light as image taking fill light is radiated toward an object from the flash light emitting unit 1, explained below, in synch with a shutter operation.

The flash light emitting unit 1 has the liquid crystal lens 3 mentioned above, liquid crystal controller 1_3, and a power source 1_5. In addition, this flash light emitting unit 1 has a light source 1_1, a reflector 1_2, and a communication unit 1_4.

The light source 1_1 radiates flash light as image taking fill light toward an object in image taking.

The reflector 1_2 is arranged in the backface of the light source 1_1 to reflect flash light, which is emitted from the light source 1_1 and goes to the backface, to the liquid crystal lens 3.

The communication unit 1_4 receives data from the CPU 124 for controlling the liquid crystal lens 3, and transmits it to the liquid crystal controller 1_3.

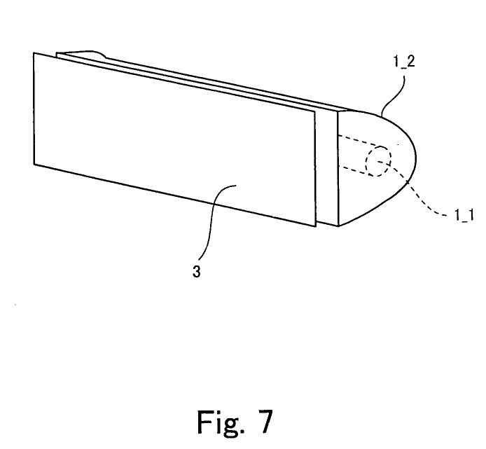

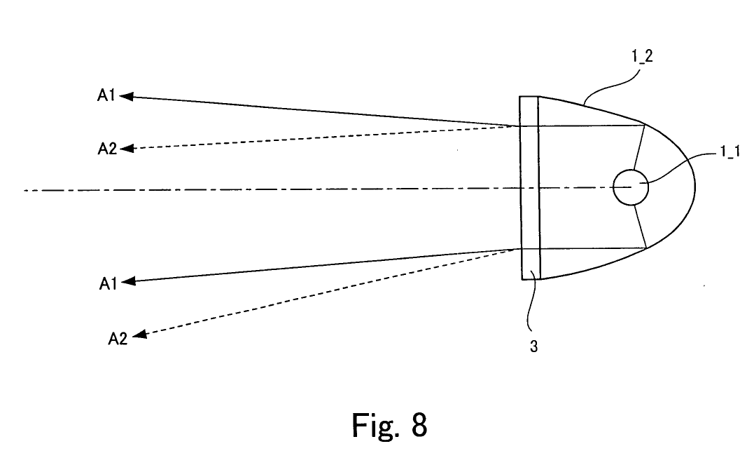

FIG. 7 is a diagram showing positional relation between the light source, reflector, and liquid crystal lens which construct the flash light emitting unit shown in FIG. 6, and FIG. 8 is a diagram showing a state that an irradiation position and irradiation angle of flash light which is emitted from the light source shown in FIG. 7 are made variable with the liquid crystal lens.

As shown in FIG. 7, the liquid crystal lens 3 is arranged in the front face of the light source 1_1, and both of flash light emitted by the light source 1_1 and flash light reflected by the reflector 1_2 are incident into the liquid crystal lens 3. As mentioned above, the liquid crystal lens 3 has the transparent electrodes 34 and 35 which are composed of two or more liquid crystal pixels 34a and 35a divided two-dimensionally, and forms in the transparent electrodes 34 and 35 a refractive index distribution according to a focal length of an image taking optical system for flash light emitted from the light source 1_1 by sequentially selecting only a part of the two or more liquid crystal pixels 34a and 35a in the transparent XY address selection sections 38 and 39 at the same time, and controlling only the part of the liquid crystal pixels 34a and 35a, which are selected sequentially, at the same time. For this reason, as shown in FIG. 8, it is possible to radiate the flash light A1 in the optical axis direction according to an object distance, or to radiate the flash light A2 in the lower direction other than the optical axis direction. In addition, a mechanical mechanism does not need to be used for this flash light emitting unit 1, and, hence, the miniaturization and the weight saving are achieved.

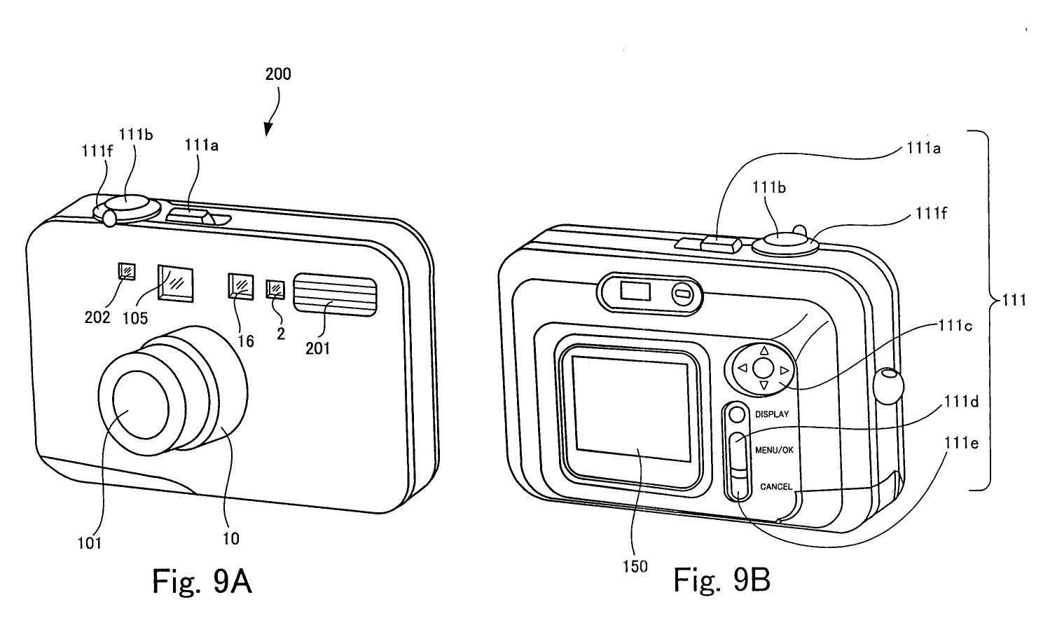

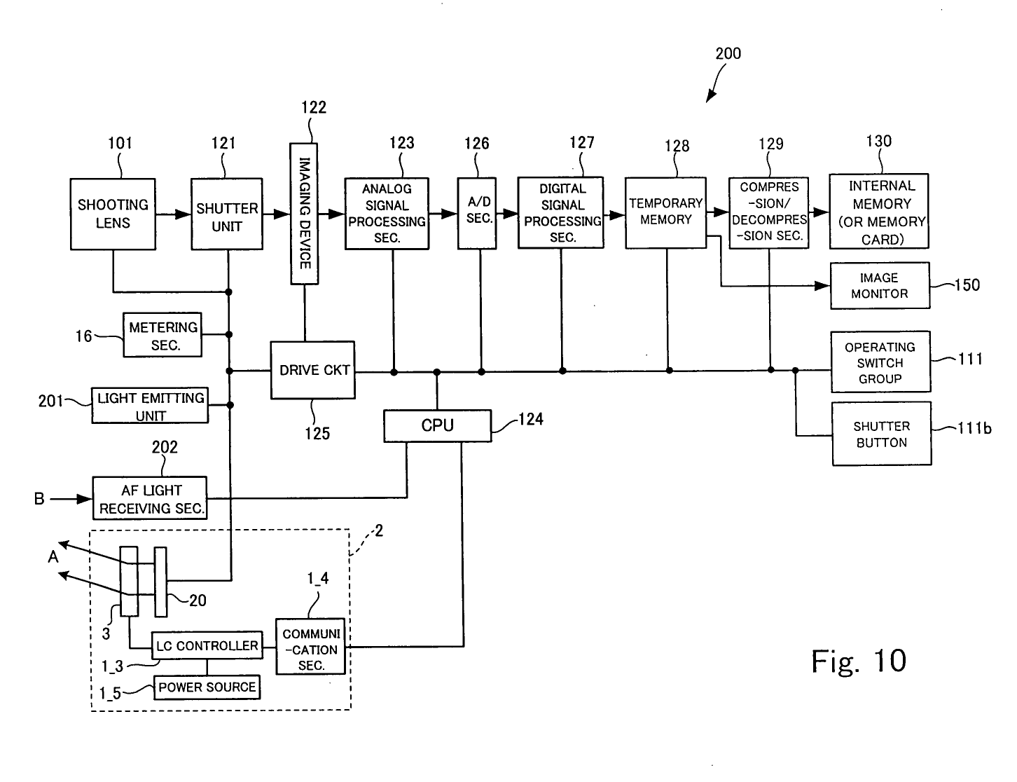

FIGS. 9A and 9B are external perspective views of a digital camera which is a second embodiment of the image taking apparatus of the present invention, and FIG. 10 is a block diagram showing the circuit configuration of the digital camera shown in FIGS. 9A and 9B.

In addition, the same reference numerals are applied to the same components as the components of the digital camera 100 shown in FIGS. 5A and 5B, and FIG. 6, and only different points will be explained.

A digital camera 200 shown in 9B has a conventional flash light emitting unit 201, and the AF light emitting unit 2 and an AF light receiving section 202 which construct an auto-focusing (AF) apparatus generally called an active type. The AF light emitting unit 2 is a unit which assists an auto-focusing (AF) function by emitting distance measurement fill light at the time of image taking under low illuminance. As shown in FIG. 10, this AF light emitting unit 2 has the liquid crystal lens 3 mentioned above, liquid crystal controller 1_3, communication section 1_4, and power source 1_5. Furthermore, this AF light emitting unit 2 has a light source 20 mentioned later. Distance measurement fill light A emitted from the AF light emitting unit 2 toward the front side of the digital camera 200 is reflected by an object, and distance measurement fill light B which is reflected and returned is received by the AF light receiving section 202, and, thereby, a distance to the object is obtained by the CPU 124.

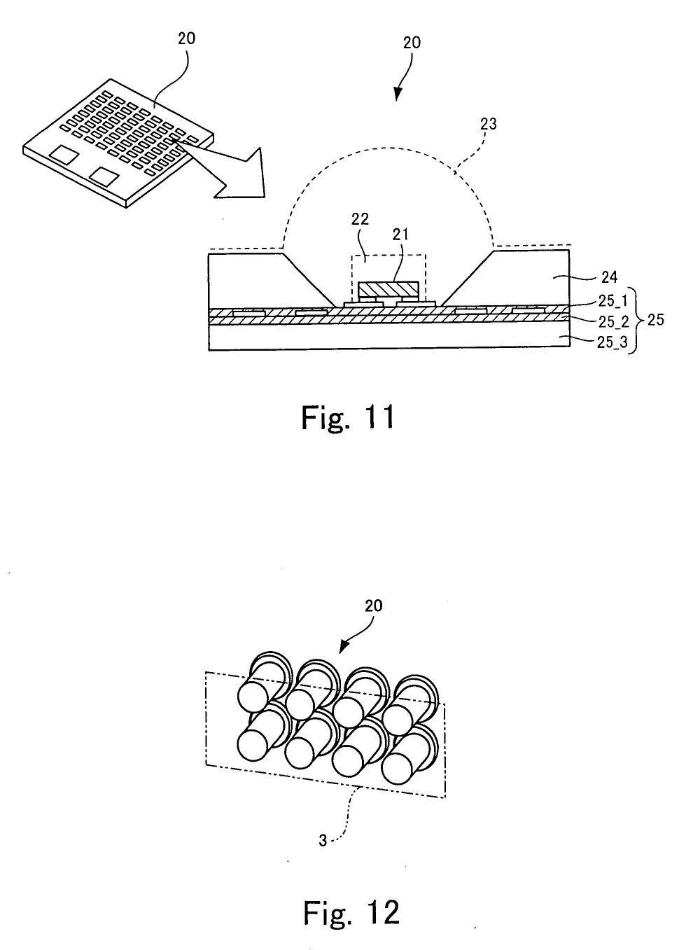

FIG. 11 is a diagram showing the configuration of the light source shown in FIG. 10.

The light source 20 shown in FIG. 11 has a metal base composite layered substrate 25 that is composed of composite layers 25_1 and 25_2, and a base metal 25_3, LED 21 in which a flip-chip is mounted on the layered substrate 25 and a phosphor 22, a lens section 23 which are formed so as to cover these LED 21 and the phosphor 22, and a reflecting plate 24. A light emitting layer of the LEDs 21 are located downward in FIG. 11, and is defined at a predetermined irradiation angle by the surrounding reflecting plate 24 and lens section 23.

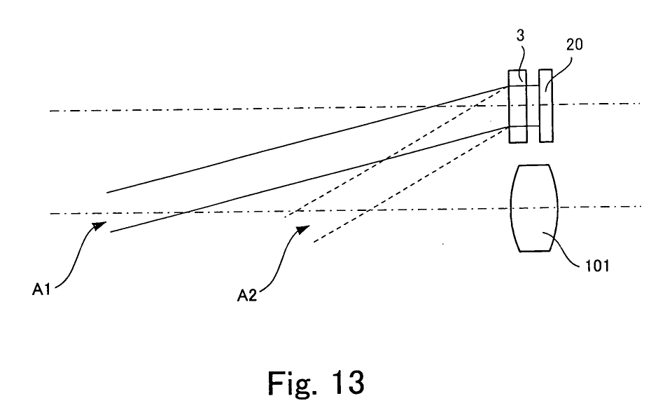

FIG. 12 is a diagram showing positional relation between the light source and liquid crystal lens which are shown in FIG. 11, and FIG. 13 is a diagram showing a state that an irradiation position and irradiation angle of distance measurement fill light which is emitted from the light source shown in FIG. 12 are made variable with the liquid crystal lens.

As shown in FIG. 12, the liquid crystal lens 3 is arranged in the. front of the light source 20, and, as shown in FIG. 13, the shooting lens 101 is provided in the lower section of the light source 20 and liquid crystal lens 3. The distance measurement fill light emitted by the light source 20 is incident into the liquid crystal lens 3. As mentioned above, when a refractive index distribution is formed in this liquid crystal lens 3 so that the refractive index may be changed so small as to form the refractive index distribution according to a focal length of the image taking optical system, as shown in FIG. 13, the distance measurement fill light A1 emitted from this liquid crystal lens 3 reaches in a long distance. Hence, it is possible to radiate the distance measurement fill light on the object located in a long distance. On the other hand, when a refractive index distribution is formed so that the refractive index may be changed largely, the distance measurement fill light A2 transmitted from this liquid crystal lens 3 reaches in a short distance. Hence, it is possible to radiate the distance measurement fill light on the object located in a short distance, as shown in FIG. 13.

The distance measurement fill light which is radiated on an object and is reflected by the object is incident into an imaging device (CCD) through the shooting lens 101 and a focus lens (not shown), and thereby, image data is generated. A focusing operation is performed on the basis of this image data. In this focusing operation, for example, so-called “hill-climbing type” continuous AF processing is performed. Thus, a focused position is decided by gradually moving a focus lens till a maximal point of an evaluation value while checking directions of increase and decrease of a focal evaluation value with performing minute movement of a focus lens along an optical axis back and forth.

Here, although the AF light emitting unit 2 is arranged above the optical axis of the shooting lens 101, it is possible to form refractive index distributions of the transparent electrodes 34 and 35 of the liquid crystal lens 3 so that the distance measurement fill light may be radiated in a lower direction other than the optical axis direction. Hence, even if the distance measurement fill light is radiated on an object located in a short distance, it is possible to prevent interference with an AF operation under the influence of parallax. In addition, it is not necessary to enlarge a light source which emits distance measurement fill light, and hence, it is possible not only to achieve miniaturization of the AF light emitting unit 2, but also to suppress power consumption.

In addition, in the embodiments mentioned above, although the examples of a digital camera are explained, the present invention is not limited to these, but can be applied to a camera, which is mounted in a cellular phone, a video camera, or the like.

What is claimed is:

1. A liquid crystal lens comprising:
an optically transparent liquid crystal plate which includes a plurality of liquid crystal pixels divided two-dimensionally; and
a liquid crystal drive section which selects only a part of the liquid crystal pixels simultaneously and controls voltage application to the selected liquid crystal pixels, the liquid crystal drive section performing voltage application control to the selected liquid crystal pixels so as to form, in the liquid crystal plate, a refractive index distribution of light transmitted through the liquid crystal plate.

2. The liquid crystal lens according to claim 1, wherein the voltage application control to the selected liquid crystal pixels is performed to liquid crystal pixels outside an approximate distribution range of the refractive index distribution.

3. The liquid crystal lens according to claim 1, wherein the voltage application control to the selected liquid crystal pixels is performed to liquid crystal pixels inside an approximate distribution range of the refractive index distribution.

4. The liquid crystal lens according to claim 1, wherein the voltage application control to the selected liquid crystal pixels is performed in sequential selection.

5. The liquid crystal lens according to claim 2, wherein the voltage application control to the selected liquid crystal pixels is performed in sequential selection.

6. The liquid crystal lens according to claim 3, wherein the voltage application control to the selected liquid crystal pixels is performed in sequential selection.

7. An image taking apparatus which has an image taking optical system with a variable focal length, captures an object light which is incident through the image taking optical system, and generates image data, the image taking apparatus comprising:
a light source which radiates fill light toward an object at image taking;
an optically transparent liquid crystal plate which is arranged in front of the light source, and includes a plurality of liquid crystal pixels divided two-dimensionally; and
a liquid crystal drive section which selects only a part of the liquid crystal pixels simultaneously and controls voltage application to the selected liquid crystal pixels, so as to form in the liquid crystal plate a refractive index distribution, according to a focal length of the image taking optical system, of the fill light emitted from the light source.

8. The image taking apparatus according to claim 7, wherein the voltage application control to the selected liquid crystal pixels is performed to liquid crystal pixels outside an approximate distribution range of the refractive index distribution.

9. The image taking apparatus according to claim 7, wherein the voltage application control to the selected liquid crystal pixels is performed to liquid crystal pixels inside an approximate distribution range of the refractive index distribution.

10. The image taking apparatus according to claim 7, wherein the voltage application control to the selected liquid crystal pixels is performed in sequential selection.

11. The image taking apparatus according to claim 8, wherein the voltage application control to the selected liquid crystal pixels is performed in sequential selection.

12. The image taking apparatus according to claim 9, wherein the voltage application control to the selected liquid crystal pixels is performed in sequential selection.

13. A flash light emitting unit comprising:
a light source
an optically transparent liquid crystal plate which is arranged in front of the light source, and includes a plurality of liquid crystal pixels divided two-dimensionally; and
a liquid crystal drive section which selects only a part of the liquid crystal pixels simultaneously and controls voltage application to the selected liquid crystal pixels, so as to form in the liquid crystal plate a refractive index distribution of the fill light emitted from the light source.

14. The flash light emitting unit according to claim 13, wherein the voltage application control to the selected liquid crystal pixels is performed to liquid crystal pixels outside an approximate distribution range of the refractive index distribution.

15. The flash light emitting unit according to claim 13, wherein the voltage application control to the selected liquid crystal pixels is performed to liquid crystal pixels inside an approximate distribution range of the refractive index distribution.

16. The flash light emitting unit according to claim 13, wherein the voltage application control to the selected liquid crystal pixels is performed in sequential selection.

17. The flash light emitting unit according to claim 14, wherein the voltage application control to the selected liquid crystal pixels is performed in sequential selection.

18. The flash light emitting unit according to claim 15, wherein the voltage application control to the selected liquid crystal pixels is performed in sequential selection.
